(19) United States
(12) Patent Application Publication
(10) Pub. No.: US 2018/0025211 A1
(43) Pub. Date: Jan. 25, 2018

(54) CELL TRACKING CORRECTION METHOD, CELL TRACKING CORRECTION DEVICE, AND STORAGE MEDIUM WHICH STORES NON-TRANSITORY COMPUTER-READABLE CELL TRACKING CORRECTION PROGRAM

(71) Applicant: OLYMPUS CORPORATION, Tokyo (JP)

(72) Inventor: Hideya ARAGAKI, Akishima-shi (JP)

(73) Assignee: OLYMPUS CORPORATION, Tokyo (JP)

(21) Appl. No.: 15/721,408

(22) Filed: Sep. 29, 2017

Related U.S. Application Data
(63) Continuation of application No. PCT/JP2015/060985, filed on Apr. 8, 2015.

(51) Int. Cl. G06K 9/00; G06F 3/0486; G06T 7/246; G06T 7/73

(52) U.S. Cl. CPC G06K 9/00134; G06T 7/74; G06F 3/0486; G06T 7/248; G06T 2207/20101; G06T 2200/24; G06T 2207/30024; G06T 2207/10056; G06T 2207/10064

(57) ABSTRACT

A processor of a cell tracking correction apparatus is configured to perform processes comprising: estimating a position of at least one cell in images acquired by time-lapse photography, and tracking the position of the cell; generating nearby area images of a nearby area including the cell from the images of photography time points of the time-lapse photography, based on the tracked position of the cell at each of the photography time points of the time-lapse photography; displaying the nearby area images on a display; accepting, via a user interface, an input of a correction amount for correcting the position of the cell with respect to one of the nearby area images displayed on the display unit; and correcting the tracked position of the cell corresponding to the nearby area image, in accordance with the correction amount.

### CROSS-REFERENCE TO RELATED APPLICATION

This application is a Continuation Application of PCT Application No. PCT/JP2015/060985, filed Apr. 8, 2015, the entire contents of which are incorporated herein by reference.

### BACKGROUND OF THE INVENTION

### 1. Field of the Invention

The present invention relates to a cell tracking correction method for correcting an error of measurement when measuring a time-series variation of a cell position of at least one tracking target cell in each of images of a time-lapse cell image group which is acquired by time-lapse (slow-speed) photographing cells which are observed by using a microscope, and relates to a cell tracking correction device and a storage medium which non-transitory stores a computer-readable cell tracking correction program.

### 2. Description of the Related Art

In researches in the biological field and medical field, for example, techniques of detecting, by a reporter assay, the biological activity of a biological sample such as a cell, have widely been utilized. In the reporter assay, a gene of a cell, which is to be examined with respect to the biological activity, is replaced with a reporter gene (green fluorescence protein (GFP), or luciferase gene, etc.) which involves, for example, fluorescence expression and/or light emission. By observing the fluorescence and/or light emission intensity, which represents the biological activity, the biological activity can be visualized. Thereby, in the reporter assay, for example, the biological sample and a biological related substance, which is to be examined, can be imaged, and the variation of the expression amount and/or shape feature in the inside and outside of the biological sample can be observed with the passing of time.

In the research field utilizing the observation which uses fluorescence and/or light emission by a reporter substance, time-lapse photography or the like is performed in order to concretely grasp a dynamic functional expression of a protein molecule in the sample. In the time-lapse photography, photography is repeated at predetermined time intervals, and thereby a plurality of cell images are acquired. These cell images are arranged in a time series, thereby forming a time-lapse cell image group. The position of a cell of interest is specified from each image of the time-lapse cell image group, and an average brightness or the like in a nearby area of a predetermined size, which centers on the cell in the image, is recorded as a fluorescence intensity and/or a light emission intensity of the cell. Alternatively, the shape of the cell in the cell image is represented as a feature amount such as circularity. Thereby, the variation of the expression amount and/or shape of the cell with the passing of time is measured.

Here, in general, a living cell constantly repeats random movements. Thus, it is necessary to exactly specify the position of the cell by following a subtle movement of the cell. However, it is a very tiresome work for a human (a researcher, etc.) to visually confirm and specify the position of the cell from each cell image of the time-lapse cell image group. Hence, in recent years, by applying image recognition techniques using a computer, a cell tracking process has been constructed which can automatically estimate the position of the cell in each cell image of the time-lapse cell image group, and which can continuously track the exact position of the cell. In this manner, various attempts have been conducted to reduce the labor in the work of tracking the cell.

However, depending on the conditions of the time-lapse photography, it is not always possible to stably photograph clear cell images. For example, in the case of photographing a fluorescent sample, there are such characteristics that the intensity of light, which is emitted from the fluorescent sample by continuously irradiating excitation light, decreases with the passing of time. It is thus difficult to photograph, with the passing of time, stable images which can be utilized for quantitative evaluation. In this case, in the cell tracking process using a computer, the cell position is, often, erroneously estimated. Therefore, it is necessary to correct an erroneous tracking result of the cell position by using some means.

Jpn. Pat. Appln. KOKAI Publication No. 2014-089191 discloses cell tracking software which applies a cell automatic tracking process, such as a particle filter algorithm, to a plurality of image frames (time-series image group), and which analyzes cell characteristics, based on a tracking result.

### BRIEF SUMMARY OF THE INVENTION

According to a first aspect of the present invention, there is provided a cell tracking correction method comprising: estimating a position of at least one cell in a plurality of images acquired by time-lapse photography, and tracking the position of the cell; generating a plurality of nearby area images of a nearby area including the cell from the images of photography time points of the time-lapse photography, based on the tracked position of the cell at each of the photography time points of the time-lapse photography; displaying the plurality of nearby area images on a display unit; accepting, via a user interface, an input of a correction amount for correcting the position of the cell with respect to one of the plurality of nearby area images displayed on the display unit; and correcting the tracked position of the cell corresponding to the nearby area image, in accordance with the correction amount.

According to a second aspect of the present invention, there is provided a cell tracking correction apparatus comprising: a display configured to display images; a user interface configured to accept an input from a user; and a processor comprising hardware, wherein the processor is configured to perform processes comprising: estimating a position of at least one cell in a plurality of images acquired by time-lapse photography, and tracking the position of the cell; generating a plurality of nearby area images of a nearby area including the cell from the images of photography time points of the time-lapse photography, based on the tracked position of the cell at each of the photography time points of the time-lapse photography; displaying the plurality of nearby area images on the display; accepting, via the user interface, an input of a correction amount for correcting the position of the cell with respect to one of the plurality of nearby area images displayed on the display unit; and correcting the tracked position of the cell corresponding to the nearby area image, in accordance with the correction amount.

According to a third aspect of the present invention, there is provided a storage medium, which non-transitory stores a computer-readable cell tracking correction program, causing a computer to realize: a cell tracking processing function of estimating a position of at least one cell in a plurality of images acquired by time-lapse photography, and tracking the position of the cell; a nearby area image generation function of generating a plurality of nearby area images of a nearby area including the cell from the images of photography time points of the time-lapse photography, based on the tracked position of the cell at each of the photography time points of the time-lapse photography; a display function of displaying the plurality of nearby area images on a display unit; a user interface function of accepting an input of a correction amount for correcting the position of the cell with respect to one of the plurality of nearby area images displayed on the display unit; and a position shift correction function of correcting the tracked position of the cell corresponding to the nearby area image, in accordance with the correction amount.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a configuration view illustrating an embodiment of a microscope system including a cell tracking correction device according to the present invention.

FIG. 2 is a view illustrating an example of a GUI screen which is a window for a GUI operation, the GUI screen being displayed on a display device by the cell tracking correction device.

FIG. 3 is an enlarged view illustrating a plurality of cropping area images which are arranged in a time series, and which are displayed in a cropping area image area on the GUI screen.

FIG. 4 is a functional block diagram illustrating the cell tracking correction device.

FIG. 5 is a cell tracking correction processing flowchart in the device.

FIG. 6 is a view illustrating display of a plurality of cropping area images which are arranged in a time series with respect to a cell in an ROI that is set at an initial position on the GUI screen.

FIG. 7 is a view illustrating a cropping area image group in which a cell on the GUI screen has begun to shift from the center of a cropping area image, and position shift correction of this cell.

FIG. 8 is a view illustrating a general correction method of a cell position on the GUI screen.

FIG. 9 is a view illustrating cropping area images which are displayed on the GUI screen after position shift correction by the device, and depression of an automatic tracking processing button.

FIG. 10 is a view illustrating depression of a feature amount calculation processing button on the GUI screen.

FIG. 11 is a view illustrating a display example of a cropping area image group in association with a plurality of cells on the GUI screen.

FIG. 12 is a view illustrating another display example of a cropping area image group in association with a plurality of cells on the GUI screen.

### DETAILED DESCRIPTION OF THE INVENTION

Hereinafter, an embodiment of the present invention will be described with reference to the accompanying drawings.

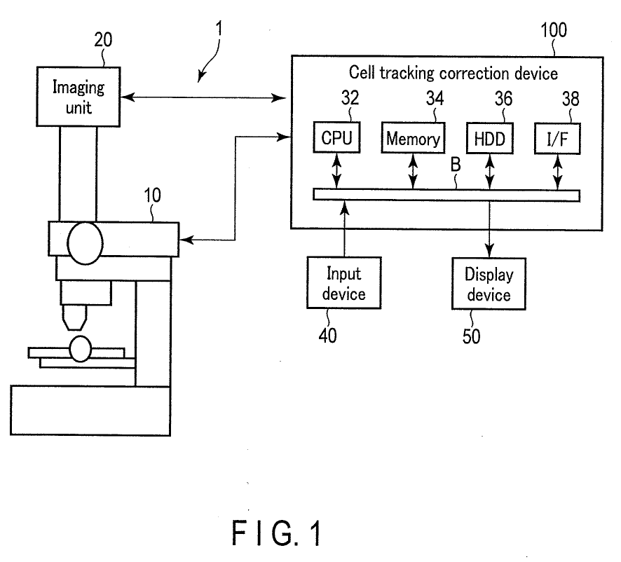

FIG. 1 is a configuration view illustrating a microscope system 1 including a cell tracking correction device 100. The microscope system 1 includes a microscope 10, an imaging unit 20, the cell tracking correction device 100, an input device 40, and a display device 50.

The microscope 10 acquires, for example, an enlarged image of a cell. This microscope 10 is, for example, a fluorescence microscope, a bright-field microscope, a phase-contrast microscope, a differential interference microscope, or the like. This microscope 10 is provided with the imaging unit 20.

The imaging unit 20 is, for example, a CCD camera, and includes an imager such as a CCD, and an A/D converter. The imager outputs analog electric signals for RGB, which correspond to the light intensity of the enlarged image of the cell. The A/D converter outputs the electric signals, which are output from the imager, as digital image signals. This imaging unit 20, when attached to an eyepiece portion of the microscope 10, captures an enlarged image of the cell, which is acquired by the microscope 10, and outputs an image signal of the enlarged image. Hereinafter, the enlarged image of the cell is referred to as “cell image”.

The imaging unit 20 converts the cell image, which is acquired by photography utilizing the fluorescence microscope, to a digital image signal, and outputs the digital image signal as, for example, an 8-bit (256 gray levels) RGB image signal. This imaging unit 20 may be, for example, a camera which outputs a multi-channel color image.

It should suffice if the imaging unit 20 acquires a cell image through the microscope 10. This microscope 10 is not limited to a fluorescence microscope, and may be, for instance, a confocal laser scanning microscope which utilizes a photomultiplier.

The imaging unit 20 photographs, by time-lapse photography, a cell at a plurality of time points which are determined by, for example, a predetermined photography cycle. Accordingly, by this time-lapse photography, a time-lapse cell image group I, which includes a plurality of cell images captured in a time series, is obtained. This time-lapse cell image group I is recorded in the cell tracking correction device 100. In this time-lapse cell image group I, a cell image at a time point of the start of photography is set as I(1), and a cell image at a time of n-th photography is set as I(n).

The cell tracking correction device 100 measures a time-series variation of the cell position of at least one tracking target cell in the cell images I(1) to I(n) of the time-lapse cell image group I which is acquired by using the microscope 10, and corrects an error of measurement at a time of measuring the time-series variation of the cell position. The microscope 10, the imaging unit 20, and the input device 40 and display device 50 functioning as user interfaces are connected to the cell tracking correction device 100.

The cell tracking correction device 100 controls the operations of the imaging unit 20 and microscope 10. This cell tracking correction device 100 executes various arithmetic operations including image processing of the cell images I(1) to I(n) acquired by the imaging unit 20.

This cell tracking correction device 100 is composed of, for example, a personal computer (PC). Specifically, the PC, which is the cell tracking correction device 100, includes a processor such as a CPU 32, a memory 34, an HDD 36, an interface (I/F) 38, and a bus B. The CPU 32, memory 34, HDD 36 and I/F 38 are connected to the bus B. For example, an external storage medium, or an external network is connected to the I/F 38. The I/F 38 can also be connected to an external storage medium or an external server via the external network.

The cell tracking correction device 100 may process not only the time-lapse cell image group I obtained by the imaging unit 20, but also respective cell images I(1) to I(n) recorded in the storage medium connected to the I/F 38, or respective cell images I(1) to I(n) acquired from the I/F 38 over the network.

The HDD 36 stores a cell tracking correction program for causing the PC to operate as the cell tracking correction device 100, when the cell tracking correction program is executed by the CPU 32. This cell tracking correction program includes a function of correcting a measurement error at a time of measuring a time-series variation of the cell position of at least one tracking target cell in the cell images I(1) to I(n) of the time-lapse cell image group I acquired by using the microscope 10. Specifically, this cell tracking correction program includes a cell tracking processing function, a cropping area image generation function, a display function, a user interface function, and a position shift correction function.

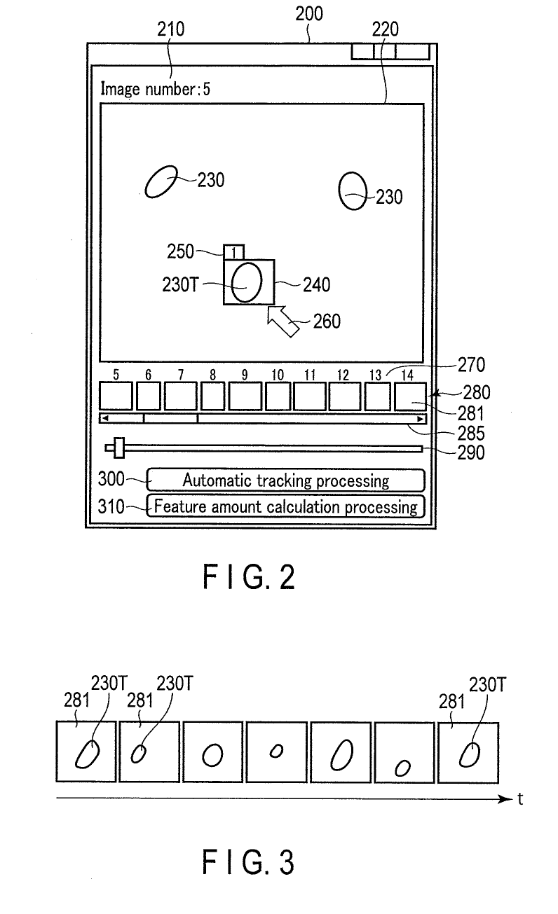

The cell tracking processing function causes the PC to estimate each of positions of at least one tracking target cell 230T of cells 230 (see FIG. 2) in a plurality of cell images I(1) to I(n) acquired by time-lapse photography, and causes the PC to track the position of the tracking target cell 230T. The cropping area image generation function causes the PC to generate, based on the position of the tracking target cell 230T tracked by this cell tracking processing function, nearby area images of nearby areas including the tracking target cell 230T, namely a plurality of cropping area images 281 as shown in FIG. 2, from the respective cell images I(1) to I(n) at respective photography time points of time-lapse photography, on the basis of the positions of the tracking target cell 230T which was tracked at the respective photography time points. The display function causes the PC to display the generated cropping area images 281 at the respective time points on the display device 50. The user interface function causes the PC to accept an input of a correction amount for correcting the position of the tracking target cell 230T with respect to one of the plural cropping area images 281 displayed on the display device 50. The position shift correction function causes the PC to correct a position shift of the tracking target cell 230T in accordance with the correction amount which was input from the user interface, when there is a cropping area image 281 including the tracking target cell 230T, the position of which is shifted, among the plural cropping area images 281 displayed on the display device 50. In the meantime, in the present specification, the position shift means that the position of the tracking target cell 230T in the cropping area image 281 is shifted relative to the central part of the cropping area image 281. In short, the position shift means that the cell tracking result is erroneous.

This cell tracking correction program may be stored in a storage medium which is connected via the I/F 38, or may be stored in a server which is connected via the network from the I/F 38.

Accordingly, by executing the cell tracking correction program stored in the HDD 36 or the like by the CPU 32, the cell tracking correction device 100 corrects the cell tracking result with respect to the respective cell images I(1) to I(n) which are output from the imaging unit 20. Specifically, the cell tracking correction device 100 corrects an error of measurement at a time of measuring the time-series variation of the cell position of at least one tracking target cell in the respective cell images I(1) to I(n) of the time-lapse cell image group I acquired by using the microscope 10.

The cell tracking result, which was corrected by the cell tracking correction device 100, is recorded in the HDD 36. The corrected cell tracking result may be recorded in an external storage medium via the I/F 38, or may be recorded in an external server via the network from the I/F 38.

Incidentally, an output device, such as a printer, may be connected to the cell tracking correction device 100.

For example, information, which is necessary for cell tracking, or for correction of cell tracking, is stored in the memory 34. Alternatively, a calculation result or the like of the CPU 32 is temporarily stored in the memory 34.

The input device 40 functions as the user interface as described above. The input device 40 includes, for example, in addition to a keyboard, a pointing device such as a mouse or a touch panel formed on the display screen of the display device 50. This input device 40 is used in order to designate an area displaying a cell that is a tracking target from the cell images I(1) to I(n), or in order to input an instruction to correct a position shift of the cell 230, the tracking result of which is erroneous.

The display device 50 includes, for example, a liquid crystal display or an organic EL display. This display device 50, together with the input device 40, constitutes a graphical user interface (hereinafter abbreviated as “GUI”). A window or the like for GUI operations is displayed on the display device 50.

FIG. 2 illustrates an example of a GUI screen 200 which is a window for a GUI operation, the GUI screen 200 being displayed on the display device 50. A cell image I(n) corresponding to an image number 210, which is, in this example, a cell image 220 of I(5), is displayed on this GUI screen 200. For example, three cells 230 appear in the cell image 220. This GUI screen 200 can display a tracking processing result of the cell 230, etc. By viewing the GUI screen 200, a user can, for example, confirm a tracking processing state of a cell, and correction progress information of the tracking result.

The GUI screen 200 includes the following GUI component elements: the image number 210, a region-of-interest (ROI) 240, an area number 250, a mouse cursor 260, a cropping area image area 280, an image number 270, a time axis display 285, a slider 290, an automatic tracking processing button 300, and a feature amount calculation processing button 310. The ROI 240 is an area of an arbitrary size, which includes the tracking target cell 230T. The area number 250 is provided in order to identify each of ROIs 240. The mouse cursor 260 enables the user to perform a GUI operation. The cropping area image area 280 represents a tracking result of the tracking target cell 230T in each cell image 220. The image numbers 270 are indicative of the numbers of the cropping area images 281 which are displayed on the cropping area image area 280. The time axis display 285 is displayed under the cropping area image area 280, and indicates which time point corresponds to the cropping area images 281 which are displayed in the cropping area image area 280. The slider 290 is used in order to change the cell image 220 which is displayed on the GUI screen 200.

In the cropping area image area 280, a plurality of cropping area images 281 are arranged and displayed in a time series. FIG. 3 is an enlarged view of the cropping area image area 280. Specifically, in this cropping area image area 280, a plurality of cropping area images 281 are displayed in a time series in accordance with the passage of time t from the left end toward the right end. Each of the cropping area images 281 is a nearby area image of the tracking target cell 230T, which is cropped from each of the cell images I(1) to I(n) of the time-lapse cell image group I, and which has a predetermined size centering on the tracking target cell 230T. The cropping area image area 280 may display a plurality of cropping area images 281 by increasing the size of the cropping area image area 280.

The cell image 220 on the GUI screen 200 is in interlock with the slider 290. The cell image corresponding to the cell image number, which is set by the slider 290, is displayed as the cell image 220 on this GUI screen 200.

The automatic tracking processing button 300 is a button for issuing an instruction to automatically estimate each of positions of at least one tracking target cell 230T in the plural cell images I(1) to I(n) acquired by time-lapse photography, and to automatically track the position of the tracking target cell 230T.

The feature amount calculation processing button 310 is a button for issuing an instruction to calculate a feature amount, such as brightness, a shape or texture, of the tracking target cell 230T at each time point, for example, based on the position of the tracking target cell 230T, which was estimated by the automatic tracking of the tracking target cell 230T.

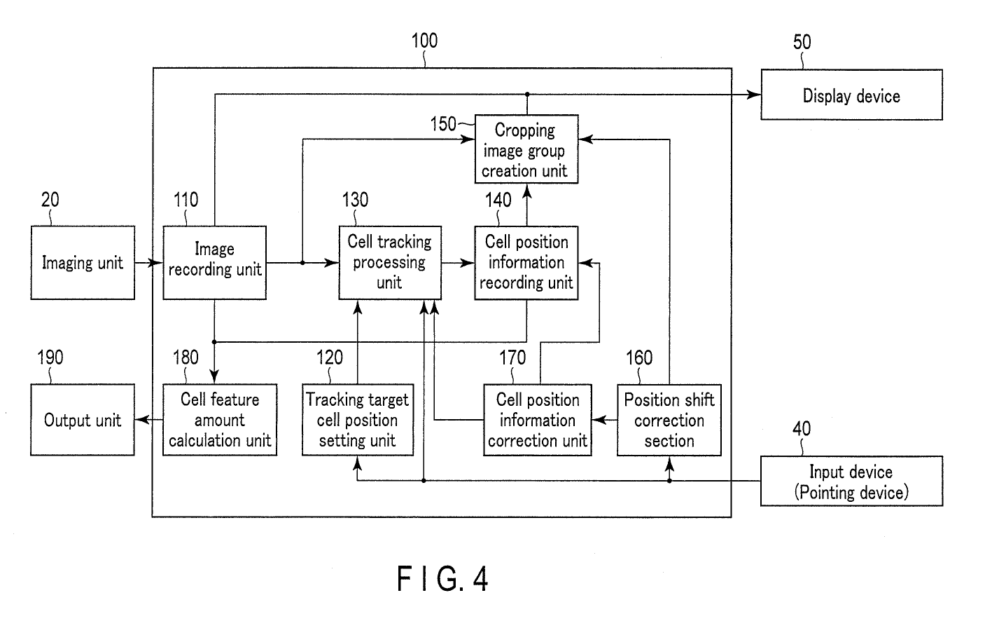

FIG. 4 is a functional block diagram illustrating the cell tracking correction device 100. This cell tracking correction device 100 includes the following functions of respective parts which are constituted by the CPU 32 executing the cell tracking correction program stored in the HDD 36: an image recording unit 110, a tracking target cell position setting unit 120, a cell tracking processing unit 130, a cell position information recording unit 140, a cropping image group creation unit 150, a position shift correction section 160, a cell position information correction unit 170, and a cell feature amount calculation unit 180. In the meantime, an output unit 190 is connected to the cell feature amount calculation unit 180.

Image signals which are output from the imaging unit 20, for example, image signals of cell images I(1) to I(n) which are photographed by using the microscope 10, are successively input to the image recording unit 110. These image signals are recorded, for example, in any one of the storage medium connected to the I/F 38, the memory 34 or the HDD 36. Thereby, the time-lapse cell image group I is generated.

The tracking target cell position setting unit 120 accepts setting of the ROI 240 for at least one arbitrary tracking target cell 230T in an arbitrary cell image I(i) on the GUI screen 200 by an operation of the input device 40, as illustrated in FIG. 2. The tracking target cell position setting unit 120 sets this ROI 240 as a position (initial position) at the start time point of tracking, and sends the information relating to this position to the cell tracking processing unit 130.

The cell tracking processing unit 130 estimates positions of the tracking target cell 230T in cell images I(i+1) to I(n) at time points after the arbitrary cell image I(i), or, in other words, tracks the position of the tracking target cell 230T. In this cell tracking processing unit 130, a predetermined image recognition technique is used in order to recognize the tracking target cell 230T.

This cell tracking processing unit 130 uses an automatic tracking process in order to track the position of the tracking target cell 230T. In this automatic tracking process, any kind of automatic tracking method may be used. In this example, a block matching process is applied as a publicly known tracking method. When there are a plurality of frame images, this block matching process searches, from the current frame image, an area most similar to the ROI 240 that is set for the tracking target cell 230T, in the frame images at time points prior to the present time point, and estimates this searched area as a position of a destination of movement of the tracking target cell 230T. In this block matching process, for example, a squared difference of a brightness value, which is called SSD (Sum of Squared Difference), is used as a similarity for measuring a degree of similarity between searched areas in the frame images.

The cell position information recording unit 140 records the position of the tracking target cell 230T in the arbitrary cell image I(i) which is set by the tracking target cell position setting unit 120, and each of the positions of the tracking target cell 230T in the respective cell images I(i+1) to I(n) estimated by the cell tracking processing unit 130. These cell positions are recorded in, for example, any one of the storage medium connected to the I/F 38, the memory 34 and the HDD 36.

The cropping image group creation unit 150 generates cropping images from the nearby area images of nearby areas each having a predetermined size and including the tracking target cell 230T in the respective cell images I(1) to I(n), based on the respective positions of the tracking target cell 230T, which are recorded by the cell position information recording unit 140. Specifically, on the GUI screen 200, as illustrated in FIG. 2, the ROI 240 is set for the tracking target cell 230T, and the cropping image group creation unit 150 crops the nearby area images of the nearby areas each including the tracking target cell 230T for which the ROI 240 is set, that is, the cropping area images 281, from the cell images I(i) to I(n) which were recorded in the storage medium or the like by the image recording unit 110. The cropping image group creation unit 150 can obtain a plurality of cropping area images (cropping image group) 281 arranged in a time series, by cropping the cropping area images 281 at the respective time points of the time-lapse photography.

When a cropping area image 281, in which the position of the tracking target cell 230T is shifted, exists among the plural cropping area images 281 which are displayed on the GUI screen 200 of the display device 50, the user corrects the position of the tracking target cell 230T, the position of which is shifted, on this cropping area image 281.

Specifically, when there is a cropping area image 281 among the plural cropping area images 281, in which the position of the tracking target cell 230T is shifted, for example; relative to the central part of this cropping area image 281, the position of the tracking target cell 230T in this cropping area image 281 on the GUI screen 200 is corrected so as to correspond to the central part, by operating the input device 40 which functions as the pointing device.

Upon accepting this operation of the input device 40, the position shift correction section 160 sends to the cropping image group creation unit 150 a correction direction and a correction amount which correspond to the operation direction and operation amount of the input device 40. In accordance with the correction direction and correction amount, the cropping image group creation unit 150 corrects the cropping position of the cropping area image from the corresponding cell image, thereby updating the cropping area image 281 that is displayed.

In addition, the position shift correction section 160 sends also to the cell position information correction unit 170 the correction direction and correction amount which correspond to the operation direction and operation amount of the input device 40.

Based on the correction direction and correction amount, the cell position information correction unit 170 corrects the cell position which is recorded in the storage medium (not shown), the memory 34 or the HDD 36 by the cell position information recording unit 140, that is, the position of the tracking target cell 230T, which was estimated by the cell tracking processing unit 130.

Besides, the cell position information correction unit 170 sends the corrected position of the tracking target cell 230T to the cell tracking processing unit 130. Thereby, when the cell tracking processing unit 130 receives a re-tracking instruction by the operation of the input device 40, the cell tracking processing unit 130 executes, from the cell image corresponding to the corrected cropping area image 281, the cell tracking, based on the ROI 240 which centers on the tracking target cell 230T included in this corrected cropping area image 281. Incidentally, at this time, the ROI 240 is automatically set in accordance with the relationship between the tracking target cell 230T, which is set by the tracking target cell position setting unit 120, and the ROI 240.

The cell feature amount calculation unit 180 calculates, from the respective cell images I(i) to I(n), the feature amount of the tracking target cell 230T at each time point of the time-lapse photography, based on the positions of the tracking target cell 230T, which are recorded in the storage medium (not shown), the memory 34 or the HDD 36 by the cell position information recording unit 140. The feature amount of the tracking target cell 230T is, for example, a brightness feature, a shape feature, or a texture feature.

The output unit 190 records the feature amount of the tracking target cell 230T, which was calculated by the cell feature amount calculation unit 180, for example, in the external storage medium (not shown) connected via the I/F 38, or in the HDD 36.

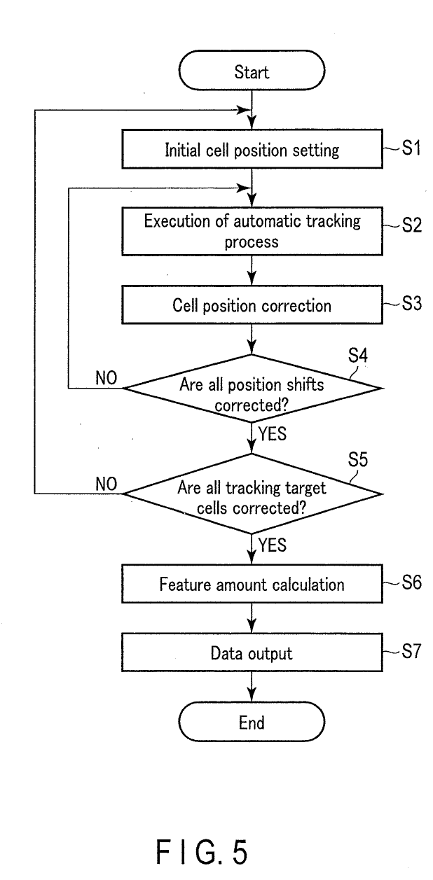

Next, the operation of the device with the above-described configuration will be described with reference to a cell tracking correction processing flowchart illustrated in FIG. 5.

(1) Acquisition of Time-Lapse Cell Image Group

The imaging unit 20 photographs an enlarged image of a cell acquired by the microscope 10, at each of time points of predetermined photography intervals by time-lapse photography, and outputs an image signal of the enlarged image. The image signal of each time-lapse photography is sent to the cell tracking correction device 100, and is recorded in the HDD 36 or the external storage medium (not shown) by the image recording unit 110 as a cell image, I(1) to I(n), of each time-lapse photography. Thereby, a time-lapse cell image group I is recorded, the time-lapse cell image group I being composed of a plurality of cell images I(1) to I(n), which were photographed in a time series by the time-lapse photography.

(2) Setting of Initial Image Number and Cell Position of Tracking Target

The CPU 32 of the cell tracking correction device 100 reads out an arbitrary cell image I(i) from the cell images I(1) to I(n) recorded by the image recording unit 110, and displays this cell image I(i) on the display device 50. For example, as illustrated in FIG. 2, the GUI screen 200 is displayed on the display device 50, and the cell image I(i) is displayed as the cell image 220 in the GUI screen 200. In the initial display, this cell image I(i) is the first cell image I(1). By sliding the slider 290 by the operation of the input device 40, the cell image, which is displayed as the cell image 220 in the GUI screen 200, can be updated. In the example of FIG. 2, for instance, the cell image I(5) of the image number (5) is designated and displayed.

At this time, since the cell tracking has not yet been executed, nothing is displayed in the cropping area image area 280 of the GUI screen 200.

In this state, in step S1, the tracking target cell position setting unit 120 accepts a GUI operation by the user, and sets the initial position of the tracking target cell 230T. Specifically, the user operates the mouse cursor 260 on the arbitrary cell image I(i) on the GUI screen 200, and sets the position of the tracking start time point of the tracking target cell 230T, that is, the initial position. Specifically, the user performs a drag-and-drop operation on the arbitrary cell image I(i) by using the mouse cursor 260 of the input device 40 which is the pointing device, thereby designating the ROI 240 so as to surround a desired tracking target cell 230T. The tracking target cell position setting unit 120 sets the center point of the ROI 240 as the position (initial position) of the tracking start time point of the tracking target cell 230T.

In conjunction with this, the tracking target cell position setting unit 120 sets a unique area number for identifying the area for the ROI 240. Here, “1” is set. The tracking target cell position setting unit 120 sends initial position information including the initial position and area number to the cell tracking processing unit 130.

The user operates the input device 40 and moves the mouse cursor 260 onto the automatic tracking processing button 300 on the GUI screen 200. If the user presses this automatic tracking processing button 300, the cell tracking processing unit 130 executes an automatic tracking process in step S2.

(3) Automatic Tracking Process

The cell tracking processing unit 130 executes the automatic tracking process by a predetermined image recognition technique, with respect to the information of the initial position of the tracking target cell 230T which was set by the tracking target cell position setting unit 120, and the respective cell images I(i+1) to I(n) of the time-lapse cell image group I which was recorded by the image recording unit 110, and estimates (“cell tracking”) the cell position of the tracking target cell 230T in the respective cell images I(i+1) to I(n).

The cell positions of the tracking target cell 230T, which were estimated by the cell tracking processing unit 130, are transferred, together with the initial position of the tracking target cell 230T, to the cell position information recording unit 140, and are recorded in the storage medium (not shown), the memory 34 or the HDD 36.

The cropping image group creation unit 150 reads out the cell positions of the tracking target cell 230T in the respective cell images I(i+1) to I(n), which were recorded by the cell position information recording unit 140. The cropping image group creation unit 150 creates a plurality of cropping area images 281 by cropping (cutting out) rectangular areas of a predetermined size, which centers on the position of the tracking target cell 230T indicated by each cell position, from the respective cell images I(i+1) to I(n) of the time-lapse cell image group I recorded by the image recording unit 110. These cropping area images 281 are sent to the display device 50. Incidentally, this rectangular area of the predetermined size may be a predetermined area, or may be arbitrarily designated by the user, or may be an area corresponding to the ROI 240.

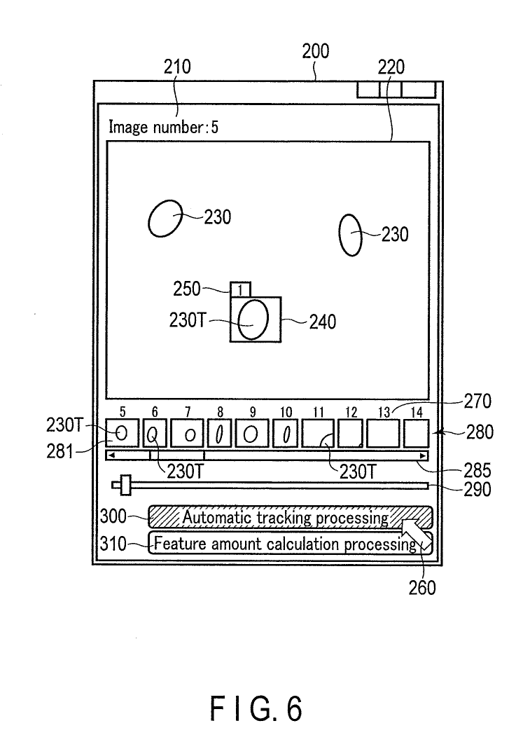

Thereby, in the cropping area image area 280 on the GUI screen 200 of the display device 50, as illustrated in FIG. 6, a plurality of cropping area images 281 are arranged and displayed in a time series, the cropping area images 281 beginning from the tracking target cell 230T of the area number 250, which is area number “1” in this example, of the ROI 240 which is set at the initial position. In this example, these cropping area images 281 are created, for example, by being cropped (trimmed) from the cell images I(5) to I(14) of the time-lapse cell image group I.

As described above, by sliding the slider 290 by the operation of the input device 40, the cell image, which is displayed as the cell image 220 in the GUI screen 200, can be updated. In accordance with the update of this cell image 220, the plural cropping area images 281, which are displayed in the cropping area image area 280, are also updated. Specifically, the update is executed such that the cropping area image 281 corresponding to the cell image 220 is displayed on the left end of the cropping area image area 280. Accordingly, the user can easily discover an error of the tracking result, by simply observing the cropping area images 281 displayed in the cropping area image area 280, while sliding the slider 290.

Specifically, in this automatic tracking process, the position of the tracking target cell 230T cannot always exactly be estimated. In many cases, due to the accumulation of errors of the estimated position of the tracking target cell 230T, an erroneous area, which is shifted from the actual position of the tracking target cell 230T, is cropped, and is displayed as the cell image I(n).

FIG. 6 illustrates display of the GUI screen 200 including a cropping area image 281 in which the tracking target cell 230T has begun to shift from the center of the cropping image area 281. In the cropping area image area 280 of this GUI screen 200, for example, a plurality of cropping area images 281, which were cropped from the cell images I(5) to I(14) acquired at times of fifth time-lapse photography to 14th time-lapse photography, are arranged and displayed in a time series. Incidentally, image numbers (5) to (14) are added to these cropping area images 281.

In this cropping area image group I, in the cropping area image 281 which is cropped from the cell image I(11), the position of the tracking target cell 230T has begun to shift from the center of this cropping image area 281. Moreover, in the cropping area image 281 which is cropped from the cell image I(13) at the time of time-lapse photography after two cycles, the position of the tracking target cell 230T is completely shifted from the center of this cropping image area 281, and is located outside the area of the cropping area image 281. In this manner, the cell tracking processing unit 130 completely erroneously estimates position of the tracking target cell 230T.

(4) Error Correction

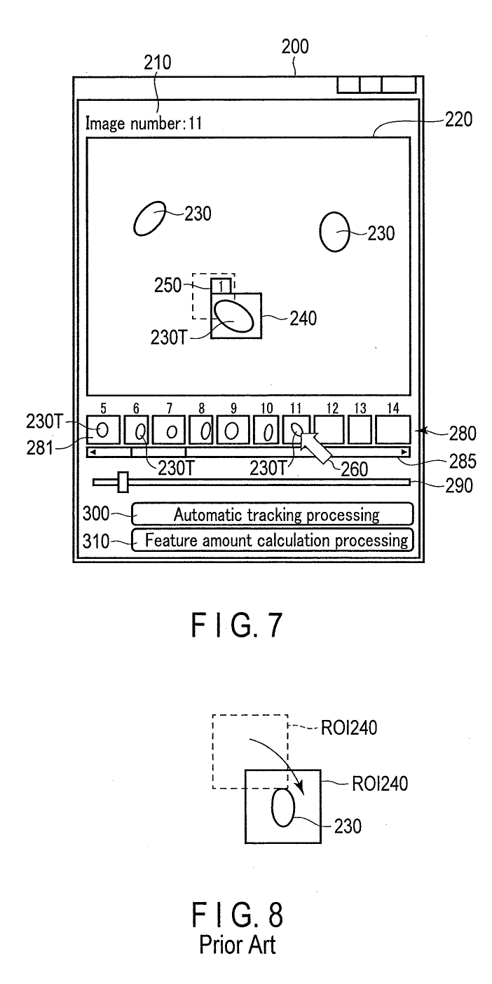

If the user confirms that the position of the tracking target cell 230T has shifted from the center of this cropping image area 281 on the GUI screen 200, the user corrects the position of the tracking target cell 230T on the GUI screen 200 such that the position of the tracking target cell 230T corresponds to the center of the cropping area image 281. Specifically, as illustrated in FIG. 7, the user moves, on the GUI screen 200, the mouse cursor 260 to the position of the tracking target cell 230T of the cropping area image 281, that is, to the cropping area image 281 cropped from the cell image I(11) in this example, and the user drags the tracking target cell 230T in this cropping area image 281. In interlock with this operation, the display of the cell image 220 on the GUI screen 200 is updated to the display of the corresponding cell image 220, which is, in this case, the cell image 220 of I(11). In addition, the position of the tracking target cell 230T, which is shifted from the center of the clopping area image 281, is moved to the center of the clopping area image 281, and is dropped.

In general, as illustrated in FIG. 8, the position shift is corrected such that the ROI 240, which is set for the tracking target cell 230T that is position-shifted, is drag-and-drop operated, and thereby the ROI 240 is moved. Thus, the tracking target cell 230T is positioned in the area of the ROI 240. By contrast, in the present embodiment, the tracking target cell 230T in the cropping area image 281 is drag-and-drop operated so as to move to the center of the cropping area image. In addition, the moving operation of the tracking target cell 230T in the cropping area image 281 is reflected on the ROI 240 in the corresponding cell image 220.

In the meantime, the position shift correction section 160 calculates the correction amount of the position shift by the drag-and-drop operation of the mouse cursor 260, from the distance and direction between the position where the mouse button was pressed at the start time of the drag-and-drop operation on the cropping area image 281, and the position where the drag-and-drop operation was finished (the position of dropping).

The position shift correction section 160 sends the correction amount of the position of the tracking target cell 230T by the GUI operation to the cell position information correction unit 170. The cell position information correction unit 170 corrects the estimation result of the cell position which is recorded by the cell position information recording unit 140, based on the correction amount of the position of the tracking target cell 230T.

Furthermore, the position shift correction section 160 also sends the correction amount of the position of the tracking target cell 230T by the GUI operation to the cropping image group creation unit 150. Based on the correction amount of the position of the tracking target cell 230T, the cropping image group creation unit 150 re-creates, from the original cell image I(11) recorded in the image recording unit 110, the cropping area image 281 in which the drag-and-drop operation was executed for the tracking target cell 230T. Furthermore, based on the above correction amount, the cropping image group creation unit 150 re-creates the plural cropping area images 281 from the subsequent cell images I(12) to I(n). This cropping image group creation unit 150 sends the plural re-created cropping area images 281 to the display device 50. Thereby, the plural cropping area images 281, which are displayed on the GUI screen 200, are updated to the plural re-created cropping area images 281.

(5) Re-Execution of Automatic Tracking Process

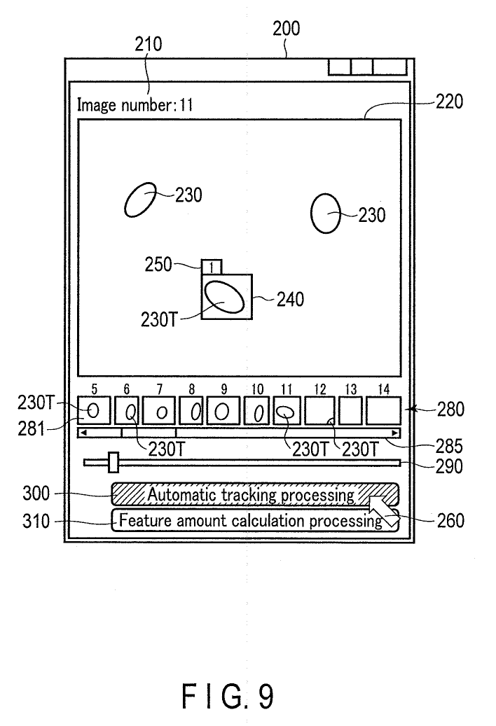

Even if the position of the tracking target cell 230T is corrected on the cropping area image 281 in this manner, the tracking result is updated only with respect to the tracking result corresponding to the cropping area image 281 on which the position shift correction operation was executed. Thus, in step S4, as illustrated in FIG. 9, the user moves once again, on the GUI screen 200, the mouse cursor 260 onto the automatic tracking processing button 300, and presses this automatic tracking processing button 300. If the automatic tracking processing button 300 is pressed, the cell tracking correction device 100 returns to the operation of step S2 and re-executes the automatic tracking process by the cell tracking processing unit 130. In this case, the cell tracking processing unit 130 may execute the re-tracking process with respect to only the cell images which were acquired at time points after the cell image (I(11)) corresponding to the cropping area image 281 on which the position shift correction operation was executed. The cell positions of the tracking target cell 230T, which were estimated by the cell tracking processing unit 130, are transferred to the cell position information recording unit 140 and are recorded.

In the same manner as described above, the cropping image group creation unit 150 re-creates the plural cropping area images 281 which are cropped from the cell images I(5) to I(n) recorded by the image recording unit 110. In this case, too, the cropping image group creation unit 150 may re-create the cropping area images 281 only from the cell images I(12) that is next to the cell image corresponding to the cropping area image 281 on which the position shift correction was made. As regards the cropping area images 281 prior to this cropping area image 281, the previously created cropping area images 281 may be used as such. These cropping area images 281 are sent to the display device 50, and thereby the cropping area images 281 are arranged and displayed in a time series in the cropping area image area 280 on the GUI screen 200 of the display device 50.

Subsequently, while sliding the slider 290 on the GUI screen 200, the user views the cropping area images 281 which are displayed in the clopping area image area 280 and are arranged in a time series with respect to the tracking target cell 230T of the area number “1”. Each time the user discovers that the position of the tracking target cell 230T is shifted from the center of the cropping area image 281, the user repeats the operation of correcting the position of the tracking target cell 230T on the GUI screen 200 such that the position of the tracking target cell 230T corresponds to the center of the cropping area image 281.

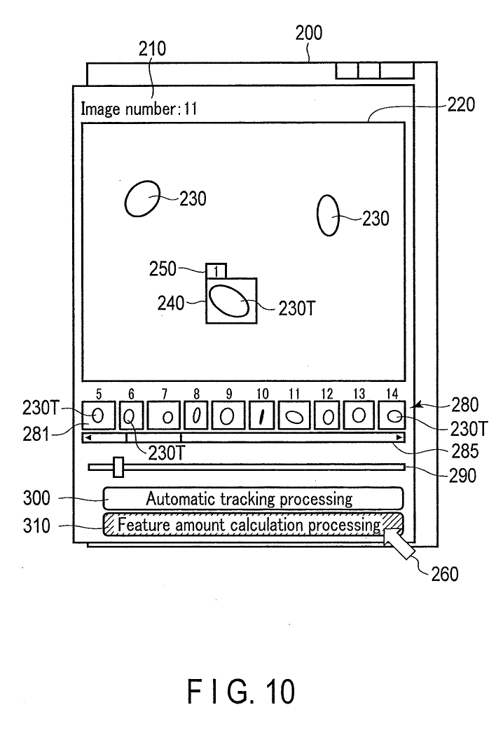

In this manner, if the correction of the position shift is completed with respect to the tracking target cell 230T of the area number “1”, the position shift of the tracking target cell 230T is corrected, for example, as illustrated in FIG. 10, in the cropping area images 281 following the 11th cropping area image 281 in which the position shift of the tracking target cell 230T existed, and the tracking target cell 230T is positioned at the center of the image in all cropping area images 281.

If the correction of the position shift is completed with respect to the tracking target cell 230T of the area number “1” as described above, the user can additionally designate another cell 230 as the tracking target cell 230, and can repeat the above-described process.

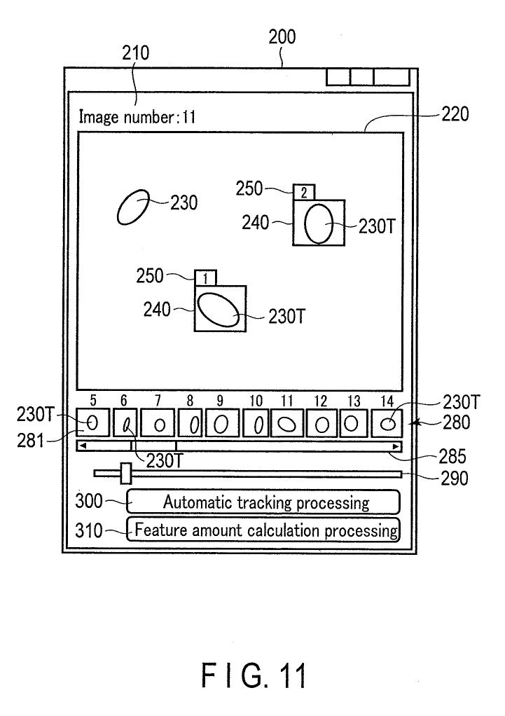

When the tracking process for another cell 230 is desired as described above, the user instructs, in step S5, the cell tracking correction device 100 to repeat the operation from step S1. Specifically, as illustrated in FIG. 11, in an arbitrary cell image I(i) on the GUI screen 200, an ROI 240 is designated so as to surround another desired tracking target cell 230T. Thereby, an area number “2” is set for this ROI 240.

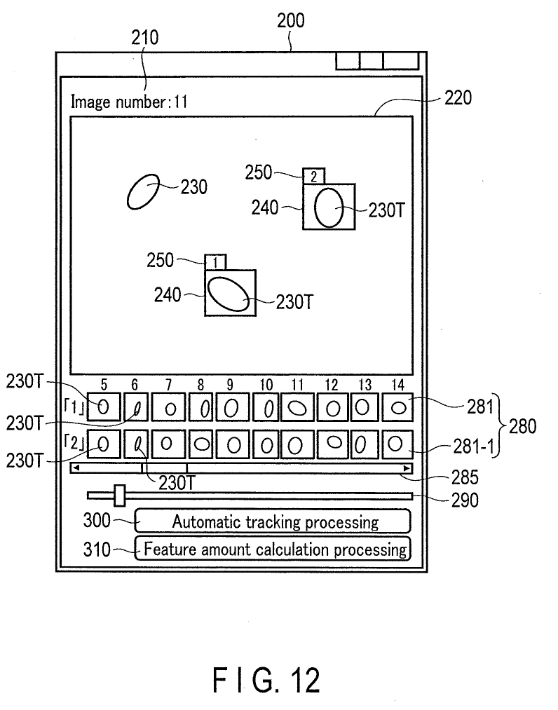

In addition, the operation of the above-described step S2 to step S4 is executed with respect to the tracking target cell 230T of area number “2”. In the meantime, in this case, since there are a plurality of tracking target cells 230T, a plurality of cropping area images 281 are arranged in a time series in the cropping area image area 280 on the GUI screen 200, as illustrated in FIG. 12, with respect to each of the tracking target cells 230T. Specifically, a plurality of cropping area images 281 of the tracking target cell 230T of the area number “1”, and a plurality of cropping area images 281-1 of the tracking target cell 230T of the area number “2” are displayed in parallel at the same time.

In the meantime, although the case in which two tracking target cells 230T are designated was illustrated here, it is possible, needless to say, to designate a greater number of tracking target cells 230T.

(6) Calculation Process of Feature Amount

If all position shift corrections are finished with respect to all tracking target cells 230T, the feature amount calculation processing button 310 on the GUI screen 200 is pressed by the user, for example, as illustrated in FIG. 10. In step S6, the cell feature amount calculation unit 180 calculates the feature amount of the tracking target cell 230T with respect to each of the cell images I(i) to I(n), based on the cell images I(i) to I(n) of the time-lapse cell image group I recorded by the cell position information recording unit 140, and based on the cell images I(i) to I(n) recorded by the image recording unit 110.

The feature amount of the cell 230 is, for example, brightness, a shape, or texture. In this case, for example, the brightness is calculated. Specifically, the brightness is calculated by a mean value of pixel values of a pixel group included in the rectangular area of the predetermined size entering on the position of the tracking target cell 230T in each of the cell images I(i) to I(n). In step S7, the feature amounts of the tracking target cell 230T are transferred to the output unit 190, and are recorded in a predetermined medium.

In the meantime, in this configuration, after the tracking process, the feature amount is calculated by pressing the feature amount calculation processing button 310. However, such a configuration may be adopted that the feature amount calculation process is automatically executed immediately after the tracking process, without pressing the button.

In this manner, according to the above-described embodiment, when the plural cropping area images 281 that are displayed on the GUI screen 200 includes a cropping area image 281 in which the position of the tracking target cell 230T is shifted relative to the position of the central part of the cropping area image 281, the GUI operation on the GUI screen 200 is executed for the tracking target cell 230T of this cropping area image 281, and the position of the tracking target cell 230T is corrected and moved to the central part of the cropping area image 281. Thereby, the error of measurement of the cell position can easily be corrected at the time of measuring the time-series variation of the cell positions in the cell images I(i) to I(n) of the time-lapse cell image group I, based on the correction amount of the position shift at the time of correcting the position of the tracking target cell 230T.

For example, when the cell 230, which is a fluorescent sample, is photographed, there are such characteristics that the intensity of light, which is emitted from the cell 230 fluorescent sample by continuously irradiating excitation light, decreases with the passing of time. It is thus difficult to photograph, with the passing of time, stable images which can be utilized for quantitative evaluation. Consequently, even if the cell 230 that is the fluorescent sample is tracked by the cell tracking process using a computer, the position of the cell 230 is, often, erroneously estimated. By contrast, in the present microscope system 1, the erroneous estimation result of the cell position can be corrected.

By repeating the correction of the position shift with respect to the plural cropping area images 281 acquired by the time-lapse photography, the position shift in all cropping area images 281, that is, the tracking error, can be eliminated.

If the position of the tracking target cell 230T is corrected, the positions of the tracking target cell 230T in the plural cropping area images 281, which were generated temporally after the time point of generation of the cropping area image 281 in which the cell position was corrected, are corrected. Thus, the positions of the tracking target cell 230T in the plural cropping area images 281, which were generated temporally after the cropping area image 281 which was indicated by the user and in which the position shift began to occur, can automatically be corrected. Thereby, there is no need to individually correct the position of the tracking target cell 230T in the respective cropping area images 281.

Incidentally, the present invention is not limited to the above-described embodiment, and the following modifications may be made.

As regards the correction of the position of the tracking target cell 230T, in addition to the position correction of the tracking target cell 230T in the respective cropping area images 281 which were generated after the position shift began to occur, it is possible to correct the position of the cell 230 in the plural cropping area images 281 which were generated temporally before the time point of generation of the cropping area image 281 in which the position correction was made. The positions of the cell 230 in the respective cropping area images 281, which were generated temporally before the cropping area image 281 which was indicated by the user and in which the position shift began to occur, can also be automatically corrected. Thereby, even if the cropping area image 281, which is designated as the cropping area image in which a position shift has begun to occur, is not exactly the cropping area image 281 in which the position shift has begun to occur, the positions of the tracking target cell 230T in the respective cropping area images 281, in which the position shift occurs, can automatically be corrected.

Moreover, in the above-described embodiment, after the correction of the position shift in one tracking target cell 230T is finished, the process for another tracking target cell 230T is executed. However, at the time of the initial cell position setting in step S1, a plurality of tracking target cells 230T may be designated.

By doing so, a plurality cropping area images 281 corresponding to a plurality of tracking target cells 230T, for example, tracking target cells 230T of area numbers “1” and “2”, can be displayed in parallel at the same time. While position shifts of the respective tracking target cells 230T of area numbers “1” and “2” in the plural cropping area images 281, which correspond to the respective tracking target cells 230T of area numbers “1” and “2”, are being confirmed in parallel, if there is a position shift, this position shift can be corrected.

Besides, although only one cell image 220 was displayed on the GUI screen 200, a plurality of cell images 220 may, needless to say, be displayed.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A cell tracking correction method comprising:
estimating a position of at least one cell in a plurality of images acquired by time-lapse photography, and tracking the position of the cell;
generating a plurality of nearby area images of a nearby area including the cell from the images of photography time points of the time-lapse photography, based on the tracked position of the cell at each of the photography time points of the time-lapse photography;
displaying the plurality of nearby area images on a display unit;
accepting, via a user interface, an input of a correction amount for correcting the position of the cell with respect to one of the plurality of nearby area images displayed on the display unit; and
correcting the tracked position of the cell corresponding to the nearby area image, in accordance with the correction amount.

2. The cell tracking correction method of claim 1, wherein the plurality of nearby area images are arranged and displayed in a time series on the display unit.

3. The cell tracking correction method of claim 2, wherein
at least one image of the plurality of images acquired by the time-lapse photography, and the plurality of nearby area images, are displayed on the display unit, and
the plurality of nearby area images and the image are linked.

4. The cell tracking correction method of claim 1, wherein the input of the correction amount is an input of a movement amount for moving the cell, of which the position in the nearby area image is shifted relative to a position of a central part of the nearby area image, such that the cell corresponds to the central part of the nearby area image.

5. The cell tracking correction method of claim 4, wherein the input of the movement amount is executed by a drag-and-drop operation of dragging the cell in the nearby area image, moving the cell to the central part of the nearby area image, and dropping the cell.

6. The cell tracking correction method of claim 4, wherein, in accordance with the correction of the position of the cell, the correction of the positions of the cell in the plurality of nearby area images, which are generated from images acquired after a time point of acquisition of the image that is a basis of the nearby area image to be corrected the position of the cell, is executed based on the movement amount that is input.

7. The cell tracking correction method of claim 4, wherein, in accordance with the correction of the position of the cell, the correction of the positions of the cell in the plurality of nearby area images, which are generated from images acquired before a time point of acquisition of the image that is a basis of the nearby area image to be corrected the position of the cell, is executed based on the movement amount that is input.

8. The cell tracking correction method of claim 1, further comprising re-tracking the position of the cell, based on the corrected position of the cell.

9. The cell tracking correction method of claim 1, further comprising calculating a feature amount of the cell at each of time points from the image, based on the position of the cell.

10. A cell tracking correction apparatus comprising:
a display configured to display images;
a user interface configured to accept an input from a user; and
a processor comprising hardware, wherein the processor is configured to perform processes comprising:
estimating a position of at least one cell in a plurality of images acquired by time-lapse photography, and tracking the position of the cell;
generating a plurality of nearby area images of a nearby area including the cell from the images of photography time points of the time-lapse photography, based on the tracked position of the cell at each of the photography time points of the time-lapse photography;
displaying the plurality of nearby area images on the display;
accepting, via the user interface, an input of a correction amount for correcting the position of the cell with respect to one of the plurality of nearby area images displayed on the display unit; and
correcting the tracked position of the cell corresponding to the nearby area image, in accordance with the correction amount.

11. The cell tracking correction apparatus of claim 10, wherein the plurality of nearby area images are arranged and displayed in a time series on the display.

12. The cell tracking correction apparatus of claim 11, wherein
at least one image of the plurality of images acquired by the time-lapse photography, and the plurality of nearby area images, are displayed on the display, and
the plurality of nearby area images and the image are linked.

13. The cell tracking correction apparatus of claim 10, wherein the correcting the tracked position of the cell includes correcting the position of the cell of which the position in the nearby area image is shifted relative to a position of a central part of the nearby area image, such that the cell corresponds to the central part of the nearby area image.

14. The cell tracking correction apparatus of claim 13, wherein the correcting the tracked position of the cell includes correcting the position of the cell by a drag-and-drop operation of dragging the cell in the nearby area image, moving the cell to the central part of the nearby area image, and dropping the cell.

15. The cell tracking correction apparatus of claim 13, wherein, in accordance with the correction of the position of the cell, the correcting the tracked position of the cell includes correcting the positions of the cell in the plurality of nearby area images, which are generated from images acquired after a time point of acquisition of the image that is a basis of the nearby area image to be corrected the position of the cell, is executed based on the correction amount that is input.

16. The cell tracking correction apparatus of claim 15, wherein, in accordance with the correction of the position of the cell, the correcting the tracked position of the cell includes correcting the positions of the cell in the plurality of nearby area images, which are generated from images acquired before a time point of acquisition of the image that is a basis of the nearby area image to be corrected the position of the cell, is executed based on the correction amount that is input.

17. The cell tracking correction apparatus of claim 10, wherein the estimating and tracking the position of the cell including re-tracks the position of the cell, based on the corrected position of the cell.

18. The cell tracking correction apparatus of claim 10, wherein the processor is further configured to perform a process comprising calculating a feature amount of the cell at each of time points from the image, based on the position of the cell.

19. A storage medium, which non-transitory stores a computer-readable cell tracking correction program, causing a computer to realize:
a cell tracking processing function of estimating a position of at least one cell in a plurality of images acquired by time-lapse photography, and tracking the position of the cell;
a nearby area image generation function of generating a plurality of nearby area images of a nearby area including the cell from the images of photography time points of the time-lapse photography, based on the tracked position of the cell at each of the photography time points of the time-lapse photography;
a display function of displaying the plurality of nearby area images on a display unit;
a user interface function of accepting an input of a correction amount for correcting the position of the cell with respect to one of the plurality of nearby area images displayed on the display unit; and
a position shift correction function of correcting the tracked position of the cell corresponding to the nearby area image, in accordance with the correction amount.
